(19) United States
(12) Patent Application Publication
(10) Pub. No.: US 2024/0154212 A1
(43) Pub. Date: May 9, 2024

(54) APPARATUS FOR DISTRIBUTING ENERGY

(71) Applicant: CELLCENTRIC GMBH & CO. KG, Kirchheim/Teck-Nabern (DE)

(72) Inventors: Matthias JESSE, Kirchheim/Teck-Nabern (DE); Jürgen LEITZ, Kirchheim/Teck-Nabern (DE); Christoph ASSFALG, Kirchheim/Teck-Nabern (DE); Mathias KUGEL, Kirchheim/Teck-Nabern (DE); Benjamin PIECK, Kirchheim/Teck-Nabern (DE); Andreas POSVERT, Kirchheim/Teck-Nabern (DE); Florian BIESINGER, Kirchheim/Teck-Nabern (DE)

(21) Appl. No.: 18/547,205

(22) PCT Filed: Feb. 21, 2022
(86) PCT No.: PCT/EP2022/054171

§ 371 Date: Aug. 21, 2023

(30) Foreign Application Priority Data
Feb. 22, 2021 (DE) 10 2021 000 940.1

(51) Int. Cl. H01M 16/00; H01M 10/42; H02J 1/12; H02J 7/00; H02J 7/34

(52) U.S. Cl. CPC H01M 16/006; H01M 10/425; H02J 1/12; H02J 7/0031; H02J 7/34; B60L 3/0053; H01M 2010/4278; H01M 2200/103; H01M 2220/20; H01M 2250/20; H02J 2207/20

(57) ABSTRACT

The invention relates to a device for energy distribution in a fuel cell system having at least one fuel cell stack and a high-voltage battery, having electrical terminals for the fuel cell stack and the high-voltage battery, and having at least one communication interface, having a converter, a battery circuit breaker for disconnecting the high-voltage battery and the fuel cell stack, and having an emergency shutdown device for connecting the poles of the fuel cell stack, wherein the battery circuit breaker is arranged between the converter and the high-voltage battery. The device according to the invention is characterized in that an EMC filter is provided and that the battery circuit breaker is configured to disconnect both electrical poles of the connection.

The invention relates to a device for energy distribution in a fuel cell system according to the type defined in more detail in the preamble of claim 1.

The distribution of energy in a fuel cell system usually takes place via a so-called fuel interface (fuel cell interface), which is attached in the area of the fuel cell itself. In this context, for example, reference can be made to DE 10 2014 017 953 A1 of the applicant or also US 2020/0235411 A1 or US 2015/0295401 A1. In principle, such a structure is also already known from DE 100 06 781 A1.

A generic electrical energy system having such a fuel cell interface is described in DE 10 2018 213 159 A1. In this case an emergency shutdown for the battery is implemented via a battery circuit breaker after a DC-DC converter and thus between this converter and a battery. The fuel cell itself is arranged on the opposite side of the DC-DC converter and in turn includes an emergency discharge device.

The object of the present invention is now to further improve this structure of a fuel cell interface (FCI) known in principle from the prior art.

According to the invention, this object is achieved by a device for energy distribution having the features in claim 1, and here in particular in the characterizing part of claim 1. Advantageous refinements and developments result from the subclaims dependent thereon.

The structure of the device according to the invention provides a combination of fuel cell and battery, comparable to the structure in the prior art, wherein a converter is arranged between the two components, as well as an emergency shutdown device for connecting the poles of the fuel cell and a battery circuit breaker for disconnecting battery and fuel cell. This battery circuit breaker is arranged between the converter and the battery. In contrast to the prior art, it is provided in the device according to the invention that the battery circuit breaker is configured to disconnect both electrical poles of the connection. An EMC filter is additionally provided.

The structure of the device according to the invention thus ensures the electromagnetic compatibility (EMC) of the structure and increases safety in the case that the battery circuit breaker is opened because it reliably disconnects both poles between the converter and the battery via corresponding contactors. The arrangement of the battery circuit breaker after the converter results in the advantage that lower currents have to be switched than in the arrangement before the converter, which is common over long distances in the above-mentioned prior art.

According to a very advantageous refinement, the emergency shutdown device can be embodied in the device according to the invention as a pyrotechnic closer or can comprise such a closer and can be connected to an external communication interface. Such a pyrotechnic closer can be connected, for example, to crash sensors of a vehicle equipped with the device. In case of an accident, for example for the case that an airbag is triggered or the like, a signal can then be sent simultaneously via this sensor system to the device according to the invention in the described advantageous refinement in order to trigger the pyrotechnic closer and connect the poles of the fuel cell stack.

A further very advantageous embodiment of the device according to the invention provides that a microcontroller is provided for controlling components, which in turn comprises a connection to an external communication interface. This connection can in particular be a different one than that of the pyrotechnic closer in the above-described embodiment. The components here comprise at least the converter, which is typically operated as a step-up converter, and the battery circuit breakers, which are typically designed as contactors in order to disconnect both poles of the electrical connection in dependence on a control signal from the microcontroller.

According to a further very advantageous embodiment of the device according to the invention, a device for monitoring the insulation resistance can furthermore be provided, which is arranged in particular between the emergency shutdown device and the converter, i.e., on the side of the converter facing toward the fuel cell. This device can also be connected to the or one of the external communication interfaces. In this advantageous embodiment of the device according to the invention, the faultless and reliable functioning of the insulation of the fuel interface can be checked by an insulation resistance measurement. Both the positive pole and the negative pole are measured against ground for this purpose. In this case, the insulation resistance has to be several megaohms in size and is typically specified in accordance with the relevant standards. The device for monitoring the insulation resistance can then be used to measure and monitor the current value of the insulation resistance, so that if the insulation resistance deteriorates, in particular if it falls below a specified limiting value, an alarm can be triggered, which then enables further actions such as an emergency shutdown or the like.

According to a further very advantageous embodiment of the device according to the invention, an electrically isolated adjustable transformer can also alternatively or additionally be provided, which is configured for high-voltage pre-charging and is connected to a low-voltage terminal of the device. It can furthermore be controlled by the microcontroller, if this is provided in accordance with the advantageous embodiment described above. In this way, it is easily possible to adjust the voltage at the fuel cell interface to the voltage level of the battery. The voltage on the battery side can thus be used as a target value for the voltage equalization of the high-voltage pre-charging using low voltage. In particular, this enables the contacts on the high-voltage battery, which are typically implemented by contactors, to be switched on even before the fuel cell stack is supplied with its media, i.e., with air or oxygen. The actual DC-DC converter itself can then be implemented unidirectionally as a step-up converter, as is provided according to an advantageous refinement of the device according to the invention.

A further very favorable embodiment furthermore provides a device for voltage limiting of the voltage of the open circuit, which is also controlled by the microcontroller. In this way limiting of the voltage, so-called voltage clipping, of the fuel cell stack is possible. In particular in combination with the above-described embodiment of the fuel cell system according to the invention having the transformer for high-voltage pre-charging, this voltage clipping can no longer be implemented as a separate component, but rather can also be carried out by the actual DC-DC converter, which further simplifies the structure. Now that the fuel cell stack can also be loaded via the converter, limiting the voltage could also be dispensed with entirely, which means that the optional voltage limiter just described could be dispensed with entirely.

A further very favorable embodiment of the device according to the invention now also provides that at least one electrical terminal protected by fuses for ancillary units of the fuel cell system, i.e., for example, conveying devices for air, hydrogen recirculation fans, and the like, is provided between the EMC filter and the battery terminal, so that these components can also be supplied directly with power via the device and protected using fuses located in the device. According to an advantageous embodiment, the consumers themselves can then also be connected via the battery terminals or in parallel to the battery, in order to keep the structure simple and compact.

According to an advantageous refinement of the embodiment according to the invention, the entire device can be integrated into a common housing which is designed for mounting on the fuel cell, i.e., the fuel cell stack. The fuel cell interface is thus integrated into the structure of the fuel cell stack, in particular in or on its housing, in order to correspondingly reduce the wiring expenditure and to implement a single efficient interface module using the device according to the invention.

Further advantageous embodiments of the device according to the invention result from the exemplary embodiments which are described in more detail hereinafter with reference to the figures.

In the figures:

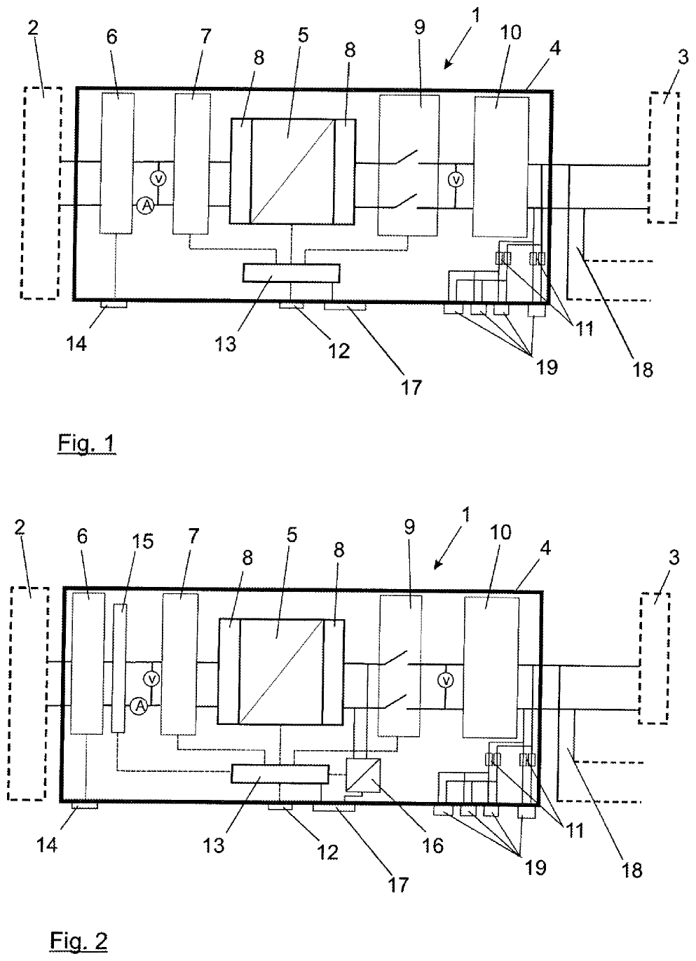

FIG. 1 illustrates a possible structure of the device according to the invention in a first embodiment;

FIG. 2 illustrates a possible structure of the device according to the invention in a second embodiment; and

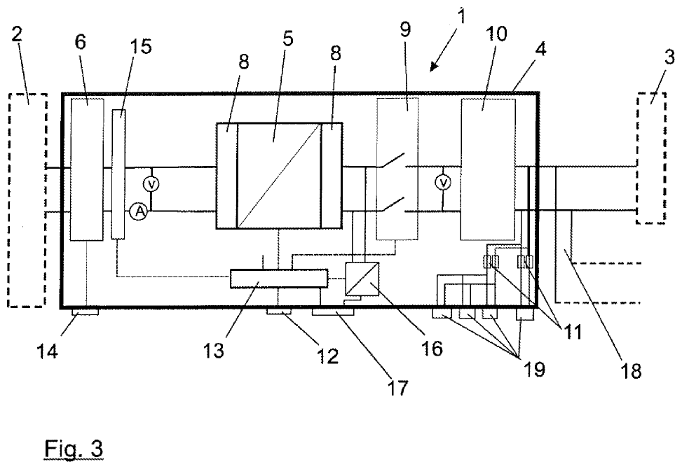

FIG. 3 illustrates a possible structure of the device according to the invention in a third embodiment.

The device 1 according to the invention is used as a fuel cell interface and is arranged according to the illustration in FIG. 1 between an indicated fuel cell stack 2 and a high-voltage battery designated by 3. In particular, it can be arranged in a housing 4, which is not specifically shown here but is merely indicated, and which is designed in particular to be connected to the fuel cell stack 2. The device 1 as a fuel cell interface in this case combines the functions of the power distribution units of a step-up converter and corresponding protective functions for the fuel cell stack 2 and/or the battery 3 in a common structural unit or a module. The device 1 thus enables an optimal and cost-effective transformation of current and voltage between the fuel cell stack 2 and the high-voltage battery 3. The relatively low voltage of the fuel cell stack 2 is stepped up by a DC-DC converter 5, which is simply referred to hereinafter as a converter 5 and is typically operated as a step-up converter, to the higher voltage of the battery 3, with largely the same power and correspondingly lower current.

The device 1 as a fuel cell interface provides the function of this converter 5 as a step-up converter, including the protection, switching, measuring, and distribution functions required for the fuel cell stack 2. It represents an efficient combination for the converter, the protective functions, and a distribution concept for the power, which can thus be optimized in particular for the use of fuel cells in vehicles such as passenger vehicles or, in particular, trucks. All of this is possible in the common housing 4, which allows modularization and combines different functions in one module. This combination saves installation space and costs and can furthermore save on terminal components and lines, in particular if the housing 4 is arranged directly in the area of the fuel cell stack 2, preferably on its stack housing. The device 1 thus enables significant cost savings with regard to series production, in particular for mobile fuel cell applications, for example in vehicles, such as trucks in particular. This applies both with respect to the hardware and with respect to the savings in time and costs during assembly.

The first possible structure of such a device 1 shown in FIG. 1 now comprises the above-mentioned converter 5 in the housing 4. Between this converter 5 and the fuel cell stack 2 or the electrical terminals of the fuel cell stack 2 on the device 1, a pyrotechnic closing device 6 as well as a device 7 for voltage limiting with an open circuit are located. This is followed by the above-mentioned converter 5 as a step-up converter having a corresponding passive discharge option 8 both on the fuel cell side and on the battery side. These are each designated by 8. A battery circuit breaker 9 then follows between the converter 5 and the terminals for the high-voltage battery 3, via which, as shown here, both poles of the electrical connection can be disconnected if necessary. This is then adjoined by an EMC filter 10 having passive discharge. In addition, sensors for measuring current (A) and voltage (V) are provided. Fuses 11 are additionally provided, which are designed with corresponding interfaces 19 for the external power supply of ancillary units, for example for the power supply of fan wheels, flow compressors, coolant pumps, or the like. The device 1 furthermore comprises an external communication interface 12, via which a microcontroller 13 is connected, which is provided for controlling at least the voltage limiting device 7, the converter 5, and the battery circuit breaker 9. The pyrotechnic closing device 6 typically comprises its own external communication interface 14, which is correspondingly connected to crash sensors of the vehicle, for example.

The battery circuit breaker 9 is arranged after the converter 5 in the structure of the device 1, which means that the corresponding switches or contactors of the battery circuit breaker 9 can be designed smaller because, as shown above, due to the typical use of the converter 5 as a step-up converter, there are higher voltages but much lower currents on this side of the converter 5. This results in a further design with regard to the simple and cost-effective structure of the device 1. In order to reduce the weight of the device 1 accordingly, a step-up converter without galvanic isolation can be provided here. A separate pre-charging circuit can thus be omitted since the voltage is adjusted via the converter 5.

As already mentioned, the pyrotechnic closing device 6 can be connected to an external communication device via its own external communication interface 14. In case of a crash of the vehicle equipped with the device 1, in which, for example, the battery 3 is disconnected from the fuel cell stack 2, this can be short-circuited via the pyrotechnic closing device and thus discharged. The purpose of the voltage limiter 7, arranged here after the pyrotechnic closing device 6, is accordingly to reduce the no-load voltage of the fuel cell stack 2 for the start of the fuel cell system comprising it. The voltage limiter thus keeps the no-load voltage of the fuel cell stack 2 below the voltage of the high-voltage battery 3 for the start of the fuel cell system, in order to secure the start of the converter 5. Electrical consumers of the fuel cell system, in particular drive motors for the vehicle, are connected via the terminals 18 in parallel to the battery 3 or to the battery terminals of the device 1. An LV terminal 17 ensures that the microcontroller 13 is supplied with the low voltage (LV) of the vehicle electrical system of the vehicle.

An alternative and expanded embodiment of the device 1 according to the invention is apparent in FIG. 2. This comprises essentially the same components that have already been described previously. They are each provided with the same reference sign. In addition to this, it comprises a device for insulation resistance monitoring 15, by means of which the faultless and reliable functioning of the insulation of the device 1 can be checked. For this purpose, the positive pole and the negative pole are measured against ground. The insulation resistance between them has to be several megohms. If it falls below a specified limiting value, for example according to relevant standards, an alarm can be triggered and the system can be switched off if necessary to ensure safety.

Furthermore, the embodiment of the device 1 shown here now also includes a galvanically isolated adjustable transformer 16, which enables high-voltage pre-charging by low voltage in order to adjust the voltage at the fuel cell interface to the voltage level of the high-voltage battery. For this purpose, the voltage on the battery side is used as the target value for the voltage equalization of the high-voltage pre-charging by low voltage. This is implemented by the galvanically isolated adjustable transformer 16, which transforms the low voltage from the LV terminal 17 into high voltage (HV). It is also correspondingly controlled or regulated via the microcontroller 13. The advantages of such low-voltage pre-charging are that it is possible to connect the contacts of the fuel cell interface to the high-voltage battery 3 even before the fuel cell stack 2 is supplied with its media. The actual converter 5 can then be designed unidirectionally solely as a step-up converter. It can then also take on the task of limiting the voltage. For this purpose, the fuel cell stack 2 can be loaded in a targeted manner via the converter 5, so that the voltage limitation and the device 7 required for this can be omitted entirely, as is shown in the embodiment in FIG. 3.

Further advantages of high-voltage pre-charging by low voltage are that loading of the fuel cell stack 2 by a load peak when starting the fuel cell stack may be prevented. In addition, tests for troubleshooting the fuel cell stack could be made simpler.

What is claimed is:

1. A device for energy distribution in a fuel cell system having at least one fuel cell stack and a high-voltage battery, having electrical terminals for the fuel cell stack and the high-voltage battery, and having at least one communication interface, having a converter, a battery circuit breaker for disconnecting the high-voltage battery and the fuel cell stack, and having an emergency shutdown device for connecting the poles of the fuel cell stack, wherein the battery circuit breaker is arranged between the converter and the high-voltage battery,
wherein
an EMC filter is provided, and in that the battery circuit breaker is configured to disconnect both electrical poles of the connection.

2. The device as claimed in claim 1,
wherein
the emergency shutdown device comprises a pyrotechnic closer and is connected to an external communication interface.

3. The device as claimed in claim 1,
wherein
a microcontroller is provided for controlling components and is connected to an external communication interface.

4. The device as claimed in claim 1,
wherein
a device is provided for monitoring the insulation resistance, which is arranged in particular between the emergency shutdown device and the converter.

5. The device as claimed in claim 3,
wherein
a galvanically isolated adjustable transformer is provided, which is configured for high-voltage pre-charging and is connected to the low-voltage side of the converter and is controllable by the microcontroller.

6. The device as claimed in claim 5,
wherein
the converter is designed to be unidirectional.

7. The device as claimed in claim 3,
wherein
a device for voltage limiting, in the case of an open circuit, is provided, which is arranged between the fuel cell stack and the converter and is controllable by the microcontroller.

8. The device as claimed in claim 1,
wherein
at least one electrical terminal, protected by at least one fuse, for ancillary units of the fuel cell system is provided between the EMC filter and the high-voltage battery.

9. The device as claimed in claim 1,
wherein
main consumers are connected via battery terminals of the device.

10. The device as claimed in claim 1,
wherein
a common housing is provided for mounting on the fuel cell stack.

11. The device as claimed in claim 2,
wherein
a microcontroller is provided for controlling components and is connected to an external communication interface.

12. The device as claimed in claim 2,
wherein
a device is provided for monitoring the insulation resistance, which is arranged in particular between the emergency shutdown device and the converter.

13. The device as claimed in claim 3,
wherein
a device is provided for monitoring the insulation resistance, which is arranged in particular between the emergency shutdown device and the converter.

14. The device as claimed in claim 4,
wherein
a galvanically isolated adjustable transformer is provided, which is configured for high-voltage pre-charging and is connected to the low-voltage side of the converter and is controllable by the microcontroller.

15. The device as claimed in claim 4,
wherein
a device for voltage limiting, in the case of an open circuit, is provided, which is arranged between the fuel cell stack and the converter and is controllable by the microcontroller.

16. The device as claimed in claim 5,
wherein
a device for voltage limiting, in the case of an open circuit, is provided, which is arranged between the fuel cell stack and the converter and is controllable by the microcontroller.

17. The device as claimed in claim 6,
wherein
a device for voltage limiting, in the case of an open circuit, is provided, which is arranged between the fuel cell stack and the converter and is controllable by the microcontroller.

18. The device as claimed in claim 2,
wherein
at least one electrical terminal, protected by at least one fuse, for ancillary units of the fuel cell system is provided between the EMC filter and the high-voltage battery.

19. The device as claimed in claim 3,
wherein
at least one electrical terminal, protected by at least one fuse, for ancillary units of the fuel cell system is provided between the EMC filter and the high-voltage battery.

20. The device as claimed in claim 4,
wherein
at least one electrical terminal, protected by at least one fuse, for ancillary units of the fuel cell system is provided between the EMC filter and the high-voltage battery.
